(19) United States
(12) Patent Application Publication
(10) Pub. No.: US 2005/0133556 A1
(43) Pub. Date: Jun. 23, 2005

(54) Cargo carrier for a vehicle

(76) Inventor: Gerald L. Bolin, Bloomfield, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/955,147

(22) Filed: Sep. 30, 2004

Related U.S. Application Data
(60) Provisional application No. 60/528,661, filed on Dec. 11, 2003.

(51) Int. Cl. B60R 9/00; B60R 11/00

(52) U.S. Cl. 224/509; 224/519

(57) ABSTRACT

A cargo carrier that is attachable to the rear of a vehicle upon the vehicle chassis. The cargo carrier being positioned approximately parallel the bumper portion. The cargo carrier has a chassis mount, a carrier platform attached to the chassis mount for movement between an open position and a closed position, and a support member attached to both the chassis mount and the carrier platform for bearing the weight of the carrier platform between the open position and the closed position.

### CROSS-REFERENCE TO RELATED APPLICATIONS

This application is a conversion of U.S. Provisional Application No. 60/528,661, filed Dec. 11, 2003, which is herein incorporated by reference in its entirety.

### BACKGROUND OF THE INVENTION

The present invention relates to a cargo carrier for a vehicle. More particularly, the present invention relates to a cargo carrier which is attached to the rear of the vehicle and supported at both the front and rear of the cargo carrier by supports attached to the vehicle and pivotable away from the rear of the vehicle while still maintaining the support upon both the front and rear of the cargo carrier.

Motorized vehicles, such as cars, trucks, and vans are used to transport both people and cargo. In some instances, it may be preferred to locate the cargo outside the passenger compartment. For example, the cargo to be carried may exceed the available space within the passenger compartment or the cargo is not appropriate to be placed within the passenger compartment, such as carpenter tools or a hunter's game.

Cargo carriers of various sizes are known in the art. A wheeled cart may be towed behind the vehicle; however, fuel economy is typically poor when towing such a trailer. In addition, cargo racks that can be rigidly mounted to the roof of the vehicle are also available in the prior art; however, cargo racks mounted on the roof are often difficult to reach, may present an overhead clearance problem, and may reduce fuel economy. Furthermore, cargo carriers have been designed to attach to the rear of a vehicle by a trailer hitch; however, these cargo carriers often inhibit accessing the trunks of automobiles, the tailgates of pickup trucks, or rear doors of the vans or sports utility vehicles.

U.S. Pat. No. 5,806,737 to Clark discloses a cargo carrier for motor vehicles which is designed to be mounted to the rear of a vehicle by attaching to the trailer hitch. The Clark patent permits access to the rear of the vehicle by having a swing arm pivot from one side. However, this carrier supports the weight of the cargo carrier only upon the pivot hinge and may result in uncontrolled swinging of a cargo carrier about the pivot hinge. Therefore, the Clark patent's usefulness is tempered by the fact that it does not support the center of the carrier and one must be careful when pivoting the cargo carrier.

Therefore, a primary objective of the present invention is the provision of an improved cargo carrier for a vehicle.

A further objective of the present invention is to provide a rear mounted cargo carrier which permits a controlled pivotal movement of the cargo carrier between a closed position and an opened position which permits access to the rear of the vehicle.

A still further objective of the present invention is to provide a cargo carrier which has a cargo box separable from a cargo platform.

A still further objective of the present invention is to provide rear lighting and license plates to permit the cargo carrier to be compliant with traffic laws.

A still further objective of the present invention is to provide hinged rear lighting to prevent damage to the rear lighting when manipulating the cargo upon the cargo platform.

A still further objective of the present invention is to provide an attachment which may be adapted for a variety of vehicles.

A further objective of the present invention is the provision of a cargo carrier which is relatively inexpensive to manufacture, efficient in use and simple in operation.

### BRIEF DESCRIPTION OF THE PICTURES AND DRAWINGS

FIG. 1 is a perspective view showing the cargo carrier in an open position away from a vehicle.

FIG. 2 is a perspective view of an alternate embodiment of the cargo carrier in an open position away from the vehicle.

FIG. 3 is a front view of the chassis mount of the cargo carrier of FIG. 2.

FIG. 4 is an enlarged view of section 4 of FIG. 3.

FIG. 5 is top view of the carrier platform.

FIG. 6 is a front view of an adjustable piece below the cargo platform 44.

FIG. 7 is top view of the foldable member of the present invention.

FIG. 8 is a rear view of the carrier platform of the present invention.

FIG. 9 is a side view of the folding tail lights.

FIG. 10 is a front view of an alternate embodiment of the chassis mount with a rigidly mounted trailer hitch.

FIG. 11 is a side view of an alternative embodiment of the foldable member for use with the chassis mount of FIG. 9 having an adjustable section placed beneath the carrier platform.

FIG. 12 is an alternate embodiment of the chassis member that uses an existing vehicle hitch and receiving coupler adapters.

### DETAILED DESCRIPTION OF EXEMPLARY EMBODIMENT

The cargo carrier of the present invention is referred to by numeral 10. The cargo carrier 10 is designed to attach to a vehicle 12. The vehicle 12 may have a door 14 that swings outward and a bumper 16.

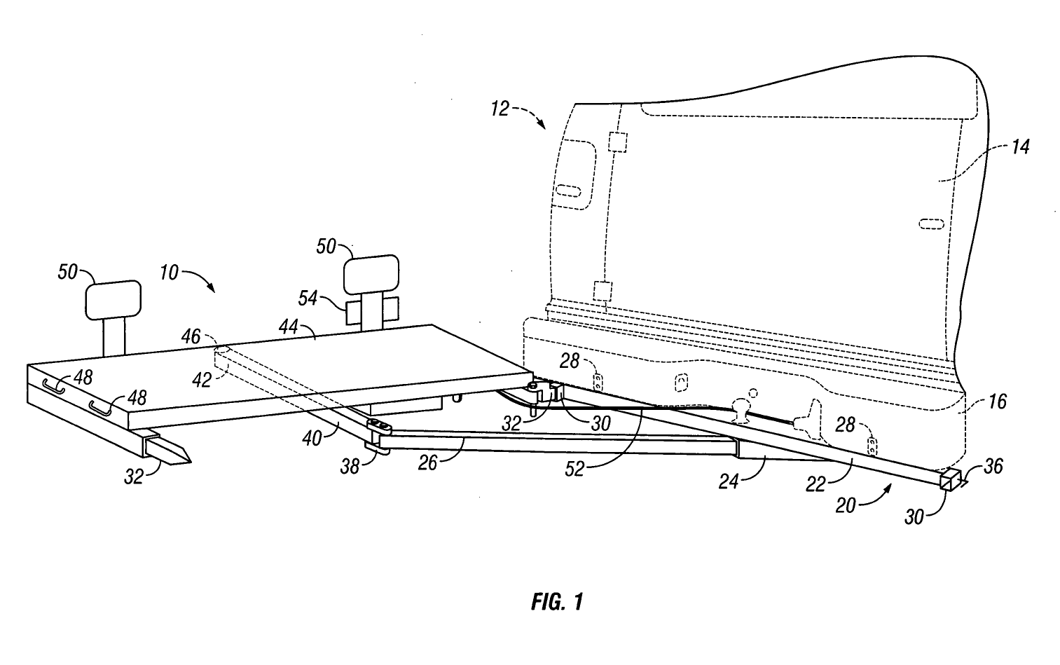

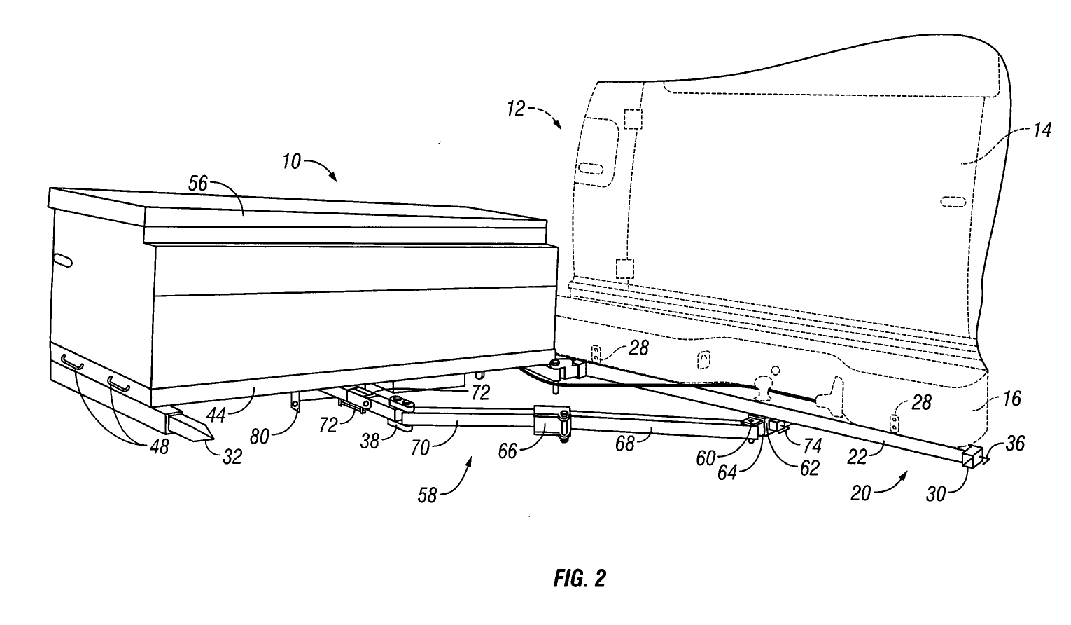

As seen in FIGS. 1 and 2, the cargo carrier 10 has a chassis mount 20 which attaches to the chassis of the vehicle 12. The chassis mount 20 has a horizontal piece 22 which is approximately parallel to the bumper 16 of the vehicle 12.

As illustrated in FIG. 1, the chassis mount 20 may have an angled piece 24 which is hollow attached to the horizontal piece 22. The angled piece 24 is designed to accept a slidable member 26. The interaction between the angled piece 24 and slidable member 26 provides support for the cargo platform 44. The chassis mount 20 has brackets 28 designed to attach to the underside of the chassis 18. The chassis mount 20 also has receiving couplers 30 designed to receive fittings 32. On one of the couplers 32 is a bolt adjustable receiver 34 to be attached to the fitting 32 and a handle 36 designed for releasably securing to the other fitting 32.

The slidable member 26 fits within the angle member 24 and attached at a pivot 38 is a support member 40. At the end of the support member 40 is a hitch or socket 42. The hitch 42 attaches to a receiving ball 46 at the rear of the carrier platform 44. The cargo platform 44 has handles 48 and tie downs on the front and back for easy carrying, handling and moving of the cargo platform 44 from a closed position to an open position. The cargo platform 44 has tail lights 50 connected to the electrical system of the vehicle 12 by electric line 52. The cargo platform 44 has license plate holder 54.

FIG. 2 illustrates an alternate embodiment of the chassis mount 20 with a cargo box 56 and foldable member 58. This chassis mount 20 does not use a slidable member 26 but rather uses a foldable member 58. The foldable member 58 is pivotally attached to the horizontal bar 22 of the chassis member 20 at a point where the slidable member typically exits the angled member 24. A first pivot 60 permits positioning of a center fitting 64 within a center receiving coupling 62. A second pivot 66 permits a first piece 68 to be folded next to a second piece 70. An adjustable piece 80 is provided to open and close the receiver arm.

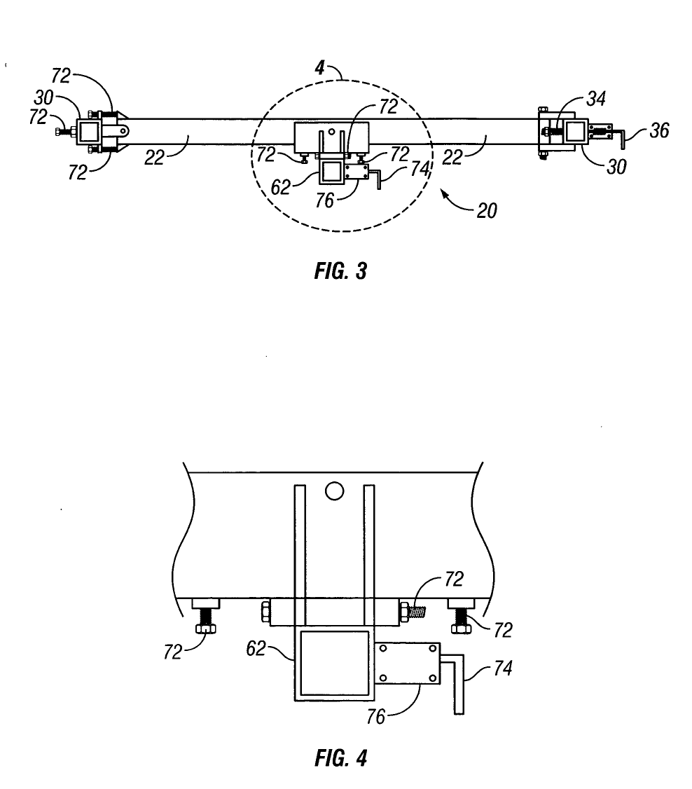

As seen in FIG. 3, the chassis mount 20 may have adjustable receiving couplers 30 with adjustable stops designed to receive fittings 32 upon the cargo platform 44. In addition, the receiving couplers 30 may have threaded bolts 72 for adjustments.

As seen in FIG. 4, a handle 74 is provided having a spring housing 76 which biases the handle to engage a center fitting 64 of the foldable member 58 inside the center receiving coupling 62.

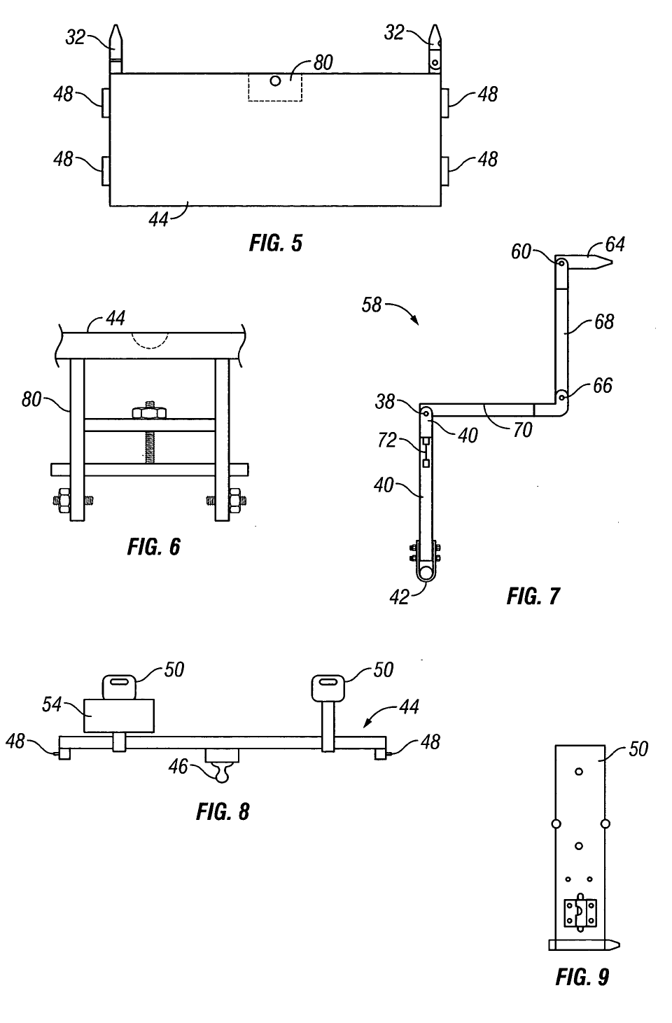

FIG. 5 illustrates a top view of the carrier platform 44. The carrier platform 44 has handles 48 on opposite side of the platform 44 for handling purposes. Fittings 32 are located at opposite sides of the carrier platform 44. The right fitting 32 as illustrated has a pivot which permits the fitting 32 to rotate into and out of the receiving coupler 30.

FIG. 6 is a front view of the adjustable piece 80 that is provided to open and close the receiver arm.

FIG. 7 is a top view of the foldable member 58 for use underneath the carrier platform 44.

FIG. 8 is a rear view of the carrier platform 44 showing a receiving ball 46 at the rear of the carrier platform 44. The support member 40 extends under the carrier platform 44 and attaches to the receiving ball 46 by hitch 42. The cargo platform 44 has tail lights 50 and a license plate holder 54. As seen in FIG. 9, the lights 50 may be hinged to permit folding downward and enable easier placement of a cargo box 56 upon the platform 44.

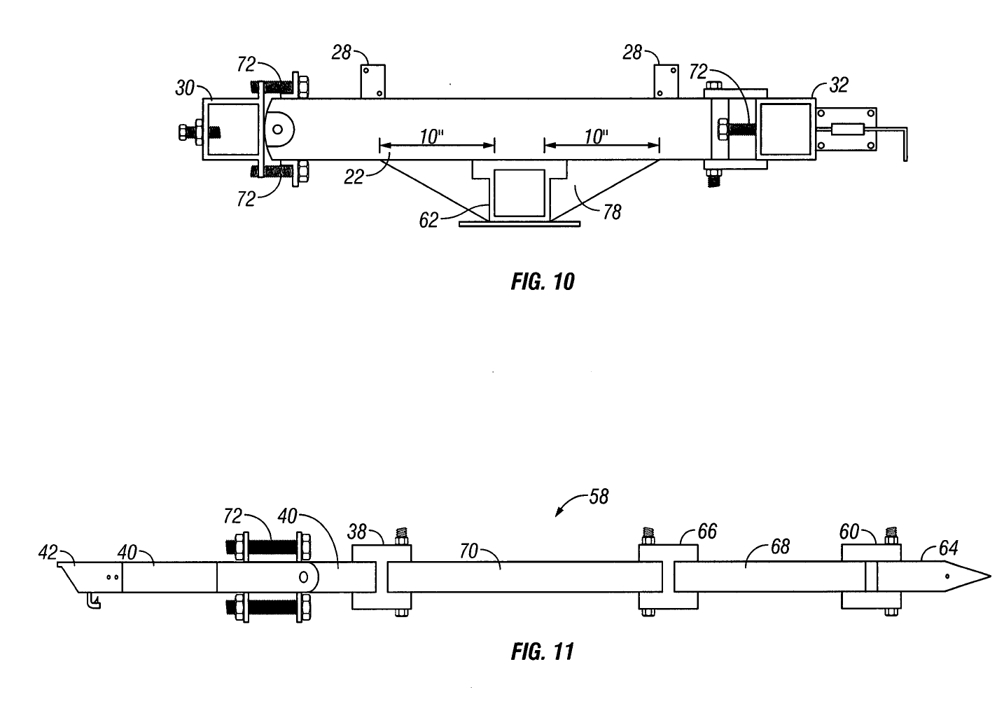

FIG. 10 is a front view of another embodiment of the chassis mount which has a rigidly mounted center receiving coupling 62. Braces 78 support the center receiving coupling 62 to the horizontal piece 22. Brackets 28 are provided to be mounted between the bumper and frame ends. Hinges and locking bolts 72 are provided for adjustments to the chassis mount 20 to permit better fitting with the carrier platform 44.

As seen in FIG. 11, the foldable member 58 has threaded bolts 72 to provide adjustment element below the carrier platform.

These and other adjustment elements are provided to assure that carrier platform moves effectively between open and closed position. These adjustment elements contribute to a smooth rotation about pivot points and insertion into the couplings by fittings 32, 64.

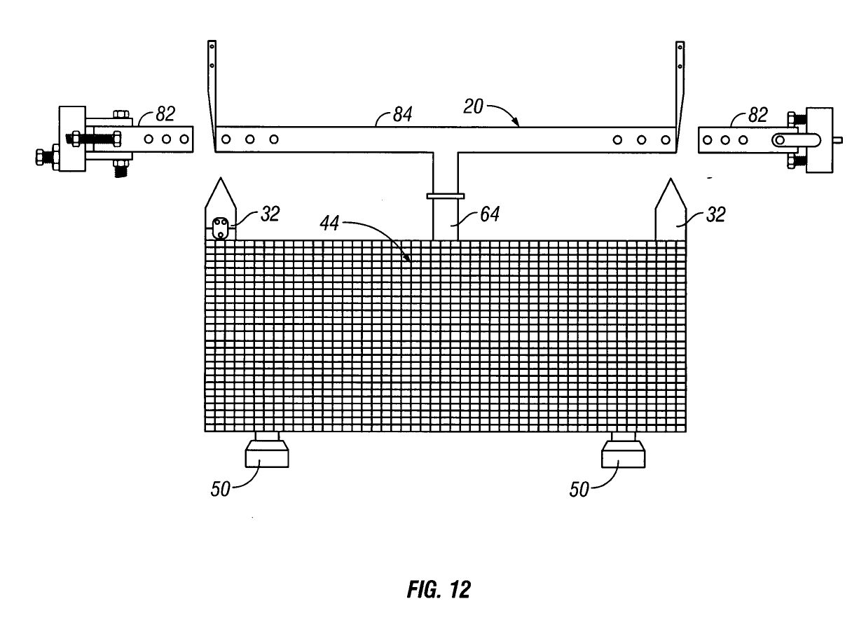

FIG. 12 is an alternate embodiment of the chassis mount 20 that uses an existing vehicle hitch 84 and receiving coupler adapters 82. Hinges and locking bolts 72 are provided for adjustments to the chassis mount 20 and the carrier platform 44 to permit better fitting with each other.

In the pictures and specification there has been set forth a preferred embodiment of the invention, and although specific terms are employed, these are used in a generic and descriptive sense only and not for purposes of a limitation. Changes in the form and the proportion of parts as well as in the substitution of equivalence are contemplated as circumstance may suggest or render expedient without departing from the scope or spirit of the invention.

1. A cargo carrier attachable to the rear of a vehicle having a chassis and a bumper portion, the cargo carrier comprising:
a chassis mount having first and second outer receiving couplers;
a carrier platform with outer fittings pivotally attached to one of the first or second outer receiving couplers for movement between an open position and a closed position;
a support member attached to the chassis mount and the carrier platform, the support member bearing weight of the carrier platform between the open position and the closed position.

2. The cargo carrier of claim 1 wherein the chassis mount has a hollow angled member for extending underneath the vehicle, the support member having a portion that is slidably received into the hollow angled member.

3. The cargo carrier of claim 1 wherein the chassis mount has an inner coupling, the support member joined to the coupling by a fitting.

4. The cargo carrier of claim 3 wherein the support member is folded in the closed position and extended in the open position.

5. The cargo carrier of claim 3 wherein the inner coupling is rigidly attached to the chassis mount, the support member having adjustments to facilitate insertion of the outer fittings into the outer receiving couplers.

6. The cargo carrier of claim 1 wherein the outer receiving couplers have adjustments to facilitate insertion of the outer fittings into the outer receiving couplers.

7. The cargo carrier of claim 1 wherein the carrier platform has handles.

8. The cargo carrier of claim 1 wherein the carrier platform has tail lights.

9. The cargo carrier of claim 1 wherein the tail lights are pivotally mounted for movement between an upright position and a downward position.

10. A cargo carrier attachable to the rear of a vehicle having a chassis and a bumper portion, the cargo carrier comprising:
a chassis mount having first and second outer receiving couplers and a hollow angled member for extending underneath the vehicle;
a carrier platform with outer fittings pivotally attached to one of the first or second outer receiving couplers for movement between an open position and a closed position;
a support member attached to the chassis mount and the carrier platform, the support member having an insertable portion that is slidably received into the hollow angled member, the support member bearing weight of the carrier platform between the open position and the closed position.

11. The cargo carrier of claim 10 wherein the hollow angled member is rigidly attached to the chassis mount, the support member having adjustments to facilitate sliding of insertable portion into the hollow angled member.

12. The cargo carrier of claim 10 wherein the chassis mount has adjustments to facilitate sliding insertion of the outer fittings into the outer receiving couplers.

13. A cargo carrier attachable to the rear of a vehicle having a chassis and a bumper portion, the cargo carrier comprising:
a chassis mount having first and second outer receiving couplers and an inner coupling;
a carrier platform with outer fittings pivotally attached to one of the first or second outer receiving couplers for movement between an open position and a closed position;
a support member attached to the inner coupling and the carrier platform, the support member bearing weight of the carrier platform between the open position and the closed position.

14. The cargo carrier of claim 13 wherein the support member is folded in the closed position and extended in the open position.

15. The cargo carrier of claim 13 wherein the inner coupling is rigidly attached to the chassis mount, the support member having adjustments to facilitate insertion of the outer fittings into the outer receiving couplers.

16. The cargo carrier of claim 13 wherein the outer receiving couplers have adjustments to facilitate insertion of the outer fittings into the outer receiving couplers.
